(19) United States
(12) Patent Application Publication
(10) Pub. No.: US 2012/0079661 A1
(43) Pub. Date: Apr. 5, 2012

(54) CUSHION STRUCTURE

(76) Inventor: Fu-Chieng CHEN, Taipei (TW)

(21) Appl. No.: 12/897,911

(22) Filed: Oct. 5, 2010

(51) Int. Cl. B68G 5/00

(52) U.S. Cl. 5/655.5; 5/652

(57) ABSTRACT

An improved cushion structure comprises: a pad, which is disposed a plurality of buffering materials therein, at least one indentation is disposed at the buffering materials, a connecting portion is between the buffering materials, the height of the connecting portion is lower than the height of the buffering materials so as to have a height difference between the buffering materials and the connecting portion, a sunken channel is existed between the buffering materials correspondingly; and a flexible melting absorbing material, which is filled into the indentations of the buffering materials, a flexible layer is then formed on the buffering materials while the flexible melting absorbing material is cured.

### BACKGROUND OF THE INVENTION

1. Field of the Invention

The present invention generally relates to an improved cushion structure, more particularly to a cushion structure that a flexible melting absorbing material is poured onto a buffering material and directly formed and adhered to the buffering material so as to avoid using chemical adhesives, environmental pollution and increasing cost, further that, the cushion structure is foldable to decrease the size thereof for easily carrying out and easy storage for using indoors, outdoors or traveling.

2. Description of the Prior Art

Prior cushion adopts a cover enclosure to cover around a foam member. Hence the foam member can be a buffering device in order to absorb the pressure as a user sits on the cushion. While the foam member is gradually becoming harder, the effect of buffering is decreasing and very limited, thus the user may not be comfortable for sitting on the cushion with a harder foam; otherwise, if using a rather soft foam, the hips of the user are sunk into the foam, namely, an uncomfortable feeling is coming as well.

To improve aforesaid disadvantage, a buffering layer is attached to the foam member, and for example the buffering layer is made of silica gel. Since the buffering layer is a solid product, adhesive is a must for adhering and positioning the buffering layer on the foam. Therefore some disadvantages can be caused and listed below:
1. The way of adhering may not only have the problems of increasing manufacturing cost and manufacturing time, but also cause environmental pollution due to that adhesive is a chemical substance.
2. The hips of the user must be moved occasionally when seated, so it is definitely uncomfortable while the buffering layer cannot remain at its original position caused by loosing the adhering force of the adhesive.

In addition to above disadvantages, such cushions in the present market mostly adopts the type of a rather mono flat surface, that is, those cushions are not foldable, therefore users cannot easily carry it to different places for sitting use and may be bothered to use them. Further, the cushion with a mono flat surface does not have enough air permeability, so that hips may accumulate too much heat and cause uncomfortable feeling for a long sitting.

Thereby, to develop an improved cushion structure with the functions of absorbing the pressure as user sitting on and being easily stored or carried out when traveling will be an excellent solution of sitting.

### SUMMARY OF THE INVENTION

The main objective of the present invention is to provide an improved cushion structure, wherein the flexible melting absorbing material is poured into the indentations of the buffering materials, the adhesive characteristic of the flexible melting absorbing material is used to let the flexible melting absorbing material adhere to the buffering materials, flexible layers are thus formed on the buffering materials after the flexible melting absorbing material is cured, so that cost-saving, time-saving for manufacturing and environmental protection are achieved.

The second objective of the present invention is to provide the improved cushion structure, wherein the pad is a foldable structure for greatly decreasing the size, so that the present invention is conveniently stored and easily carried out.

To achieve the two objectives, the improved cushion structure comprises: a pad, a flexible melting absorbing material and a covering member; wherein the pad is disposed at least two buffering materials therein and at least one indentation is disposed at the buffering materials, a connecting portion is between the two buffering materials, the height of the connecting portion is lower than the height of the buffering materials so as to form a sunken channel between the buffering materials, so that the two buffering materials can be overlapped to each other; a flexible melting absorbing material is filled into the indentations of the buffering materials, a flexible layer is then formed on the indentation between the buffering materials while the flexible melting absorbing material is cured; and the covering member covers around the pad with the flexible layer. While a user sits on the covered pad, the flexible characteristics of the flexible layers and the buffering materials make the pressure from the user sitting down be absorbed, and further that, the sunken channel is able to ventilate the air and heat in the pad in order to avoid miliaria or eczema for a long sitting and making an uncomfortable feeling. By means of the connecting portion, the two buffering materials can be overlapped to each other for easily carrying out.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic combination view of a first preferred embodiment of an improved cushion structure of the present invention;

FIG. 2 illustrates a schematic sectional view of the first preferred embodiment of the improved cushion structure of the present invention;

FIG. 3 illustrates a schematic view of the first preferred embodiment of the improved cushion structure of the present invention;

FIG. 4 illustrates a schematic sectional view of FIG. 3;

FIG. 5 illustrates a schematic application view of the first preferred embodiment of the improved cushion structure of the present invention;

FIG. 6 illustrates another schematic application view of the first preferred embodiment of the improved cushion structure of the present invention;

FIG. 7 illustrates a schematic view of a second preferred embodiment of the improved cushion structure of the present invention;

FIG. 8 illustrates a schematic view of a third preferred embodiment of the improved cushion structure of the present invention;

FIG. 9 illustrates a schematic view of a fourth preferred embodiment of the improved cushion structure of the present invention;

FIG. 10A and FIG. 10B illustrate two schematic combination views of a fifth preferred embodiment of the improved cushion structure of the present invention;

FIG. 11A and FIG. 11B illustrate two schematic combination views of a sixth preferred embodiment of the improved cushion structure of the present invention; and

FIG. 12 illustrates a schematic application view of the improved cushion structure of the present invention.

### DETAILED DESCRIPTION OF THE INVENTION

Following preferred embodiments and figures will be described in detail so as to achieve aforesaid objects.

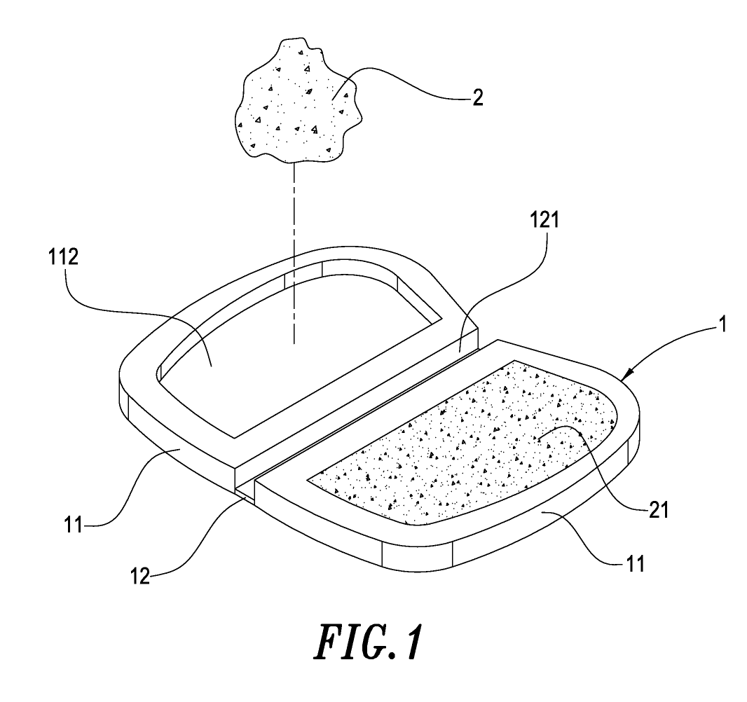

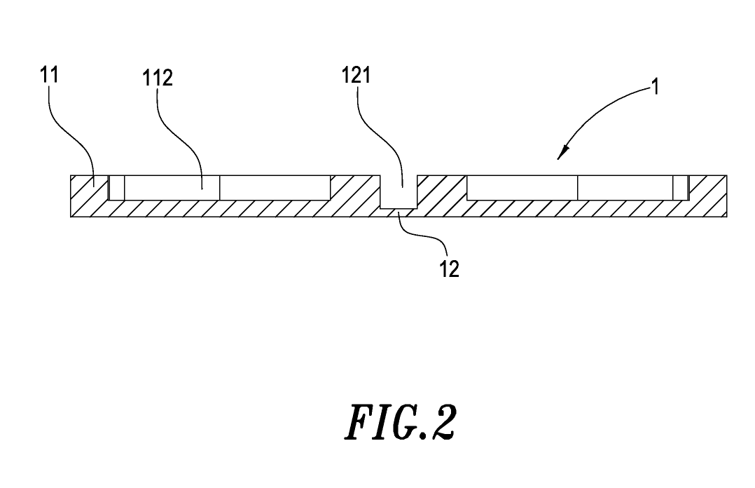

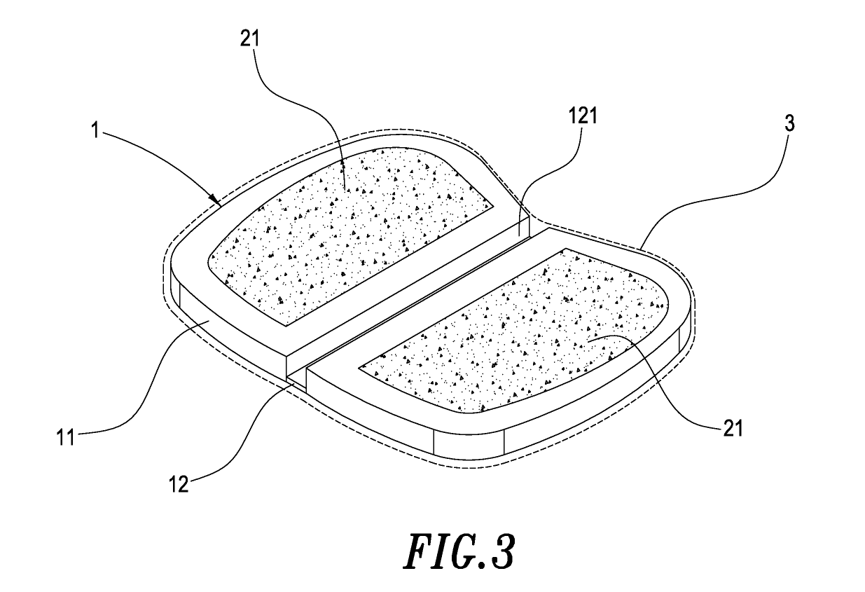

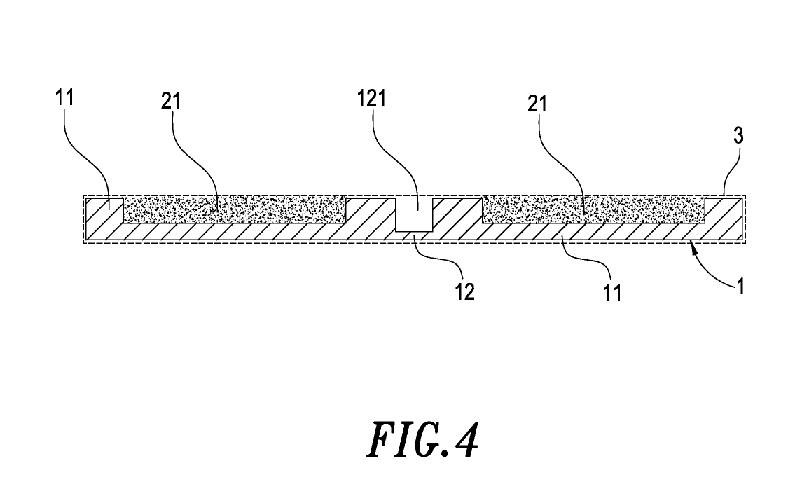

With references to FIG. 1 to FIG. 4, which illustrate a schematic combination view of a first preferred embodiment of an improved cushion structure of the present invention, a schematic sectional view of the first preferred embodiment of the improved cushion structure of the present invention, a schematic view of the first preferred embodiment of the improved cushion structure of the present invention, and a schematic sectional view of FIG. 3. The improved cushion structure includes:
a pad 1, which is disposed at least two buffering materials 11 therein, at least one indentation 112 is disposed at the buffering materials 11, a connecting portion 12 is between the buffering materials 11, the height of the connecting portion 12 is lower than the height of the buffering materials 11 so as to have a height difference between the buffering materials 11 and the connecting portion 12, a sunken channel 121 is then existed between the buffering materials 11 correspondingly, the pad 1 has closed air cells or open air cells;
a flexible melting absorbing material 2, which is filled into the indentations 112 of the buffering materials 11, the flexible melting absorbing material 2 permeates into the closed air cells or the open air cells of the buffering materials 11, the flexible melting absorbing material 2 may adhere onto the indentations 112 of the two buffering materials 11 by way of the adhesive characteristic thereof, a flexible layer 21 is then formed on the buffering materials 11 while the flexible melting absorbing material 2 is cured, the flexible layer 21 is to disperse pressure so as to have the characteristic of pressure absorption, wherein the flexible melting absorbing material 2 is selected from the group consisting of: polymer silica gel, and poly urethane;
a covering member 3, which covers around the pad 1 with the flexible layer 21 for protection and is made of fabrics or knitted fabrics, the covering member 3 can be a covering bag( [symbol] ) or two fabrics respectively covering on the upper and lower surfaces of the pad 1, the rim of the covering member 3 may be sealed or sewn by way of high welding waves or super sonic welding.

Preferably, the buffering materials 11 and the connecting portion 12 of the pad 1 are made integrally in one member via injection molding or by assembly.

Preferably, the flexible melting absorbing material 2 can be even with the edges of the top surfaces of the buffering materials 11 or exceeded the edges of the top surfaces of the buffering materials 11.

Preferably, the buffering material can be made of foam with closed air cells, foam with open air cells, rayon, or natural cotton, wherein the foam with closed air cells is made by cross-link polyethylene foam with the characteristic of closed air cells or EVA (ethylenevinyl acetate copolymer), the foam with open air cells is made by polyurethane foam with the characteristic of open air cells.

The first preferred embodiment with the two buffering materials is only an example and not limited to the present invention. In other words, any embodiment with two or more buffering materials 11 will be in the scope of the present invention.

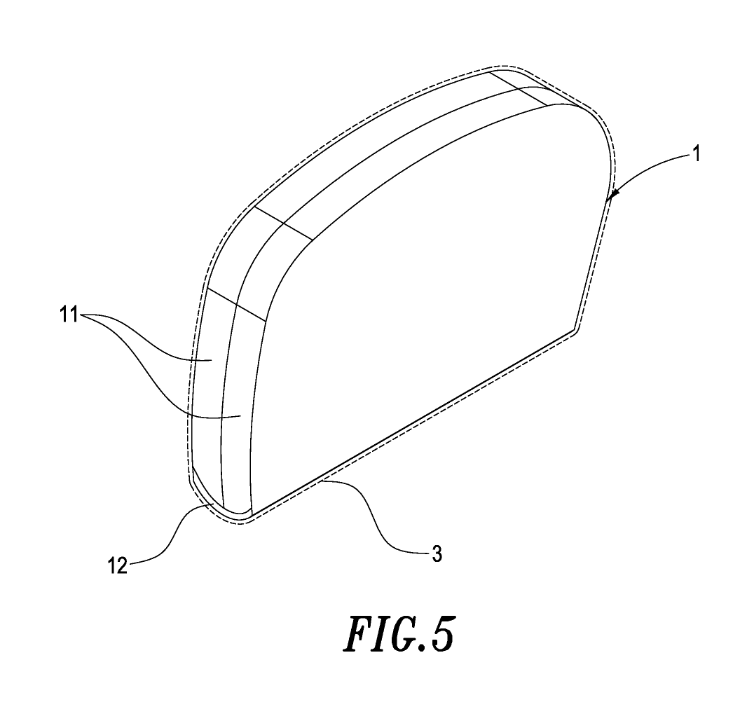

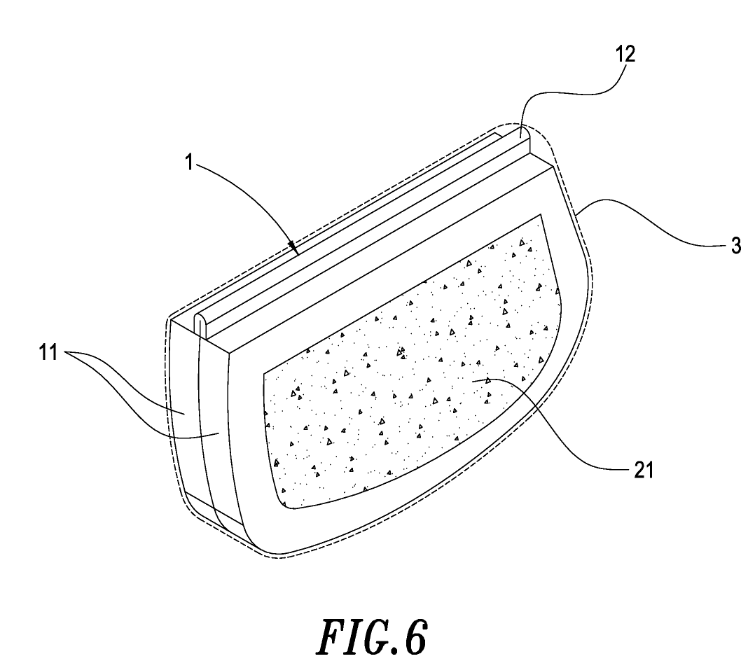

With references to FIG. 5 and FIG. 6, which illustrate a schematic application view of the first preferred embodiment of the improved cushion structure of the present invention and another schematic application view of the first preferred embodiment of the improved cushion structure of the present invention. Due to the height difference between the buffering materials 11 and the connecting portion 12, the two buffering materials 11 can be folded to overlap to each other, as shown in FIG. 5, or the two back surfaces of the two buffering materials 11 can be folded to overlap to each other, as shown in FIG. 6, so that the size for one side of the pad 1 is highly decreased for storage and carrying out.

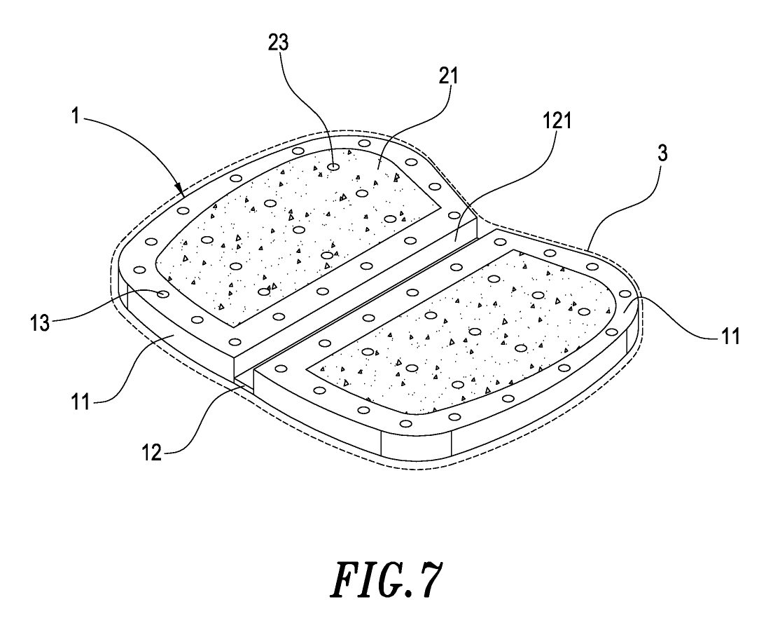

With reference to FIG. 7, which illustrates a schematic view of a second preferred embodiment of the improved cushion structure of the present invention. The differences among FIG. 7, FIG. 1 and FIG. 3 are that a plurality of through holes 13, 23 are disposed on the top surfaces of the buffering materials 11 and the flexible layers 21 in order to promote the effects of ventilation and heat-dissipation. Others are the same as FIG. 1 and FIG. 3 and may not be described any further hereinafter.

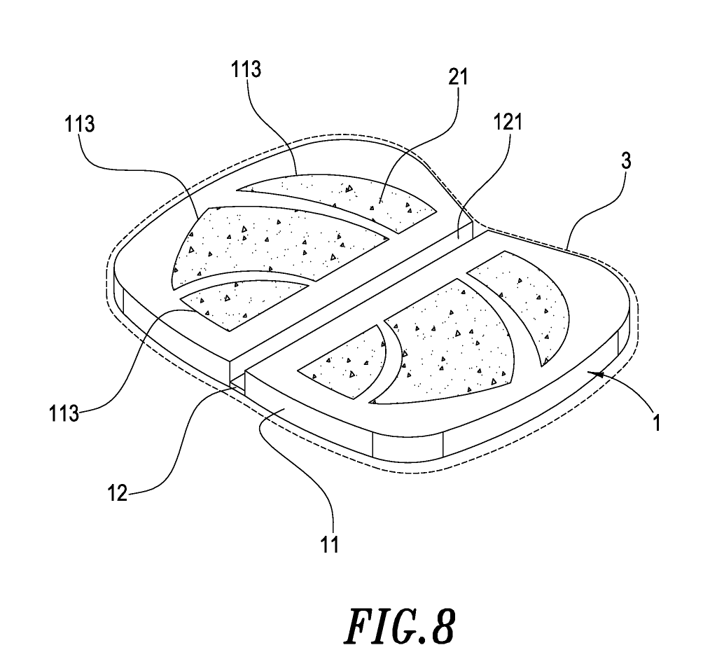

With reference to FIG. 8, which illustrates a schematic view of a third preferred embodiment of the improved cushion structure of the present invention. The differences among FIG. 8, FIG. 1 and FIG. 3 are that a plurality of fan-shaped indentations 113 filled with the flexible layers 21 are disposed on the buffering materials 11. The shapes or sizes of the indentations 13 can be the same or different, that is, such conditions may not be limited in the scope of the present invention. Others are the same as FIG. 1 and FIG. 3 and may not be described any further hereinafter.

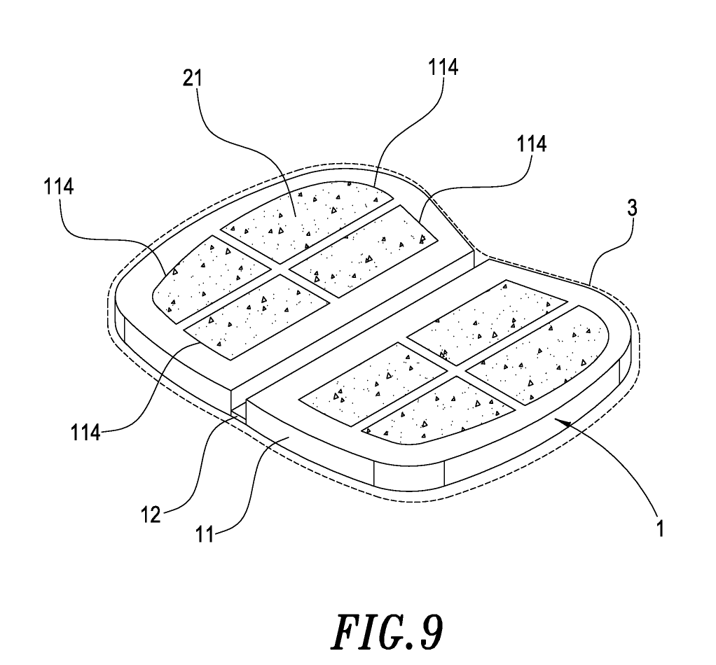

With reference to FIG. 9, which illustrates a schematic view of a fourth preferred embodiment of the improved cushion structure of the present invention. The differences among FIG. 9, FIG. 1 and FIG. 3 are that a plurality of square indentations 114 are disposed on the buffering materials 11. The shapes or sizes of the indentations 14 can be the same or different, that is, such conditions may not be limited in the scope of the present invention. Others are the same as FIG. 1 and FIG. 3 and may not be described any further hereinafter.

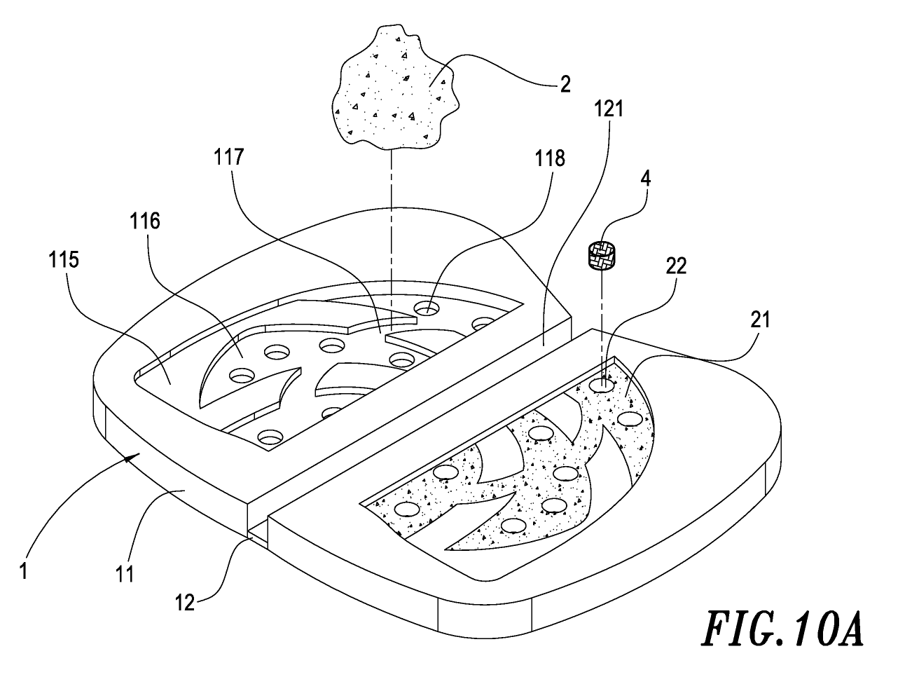

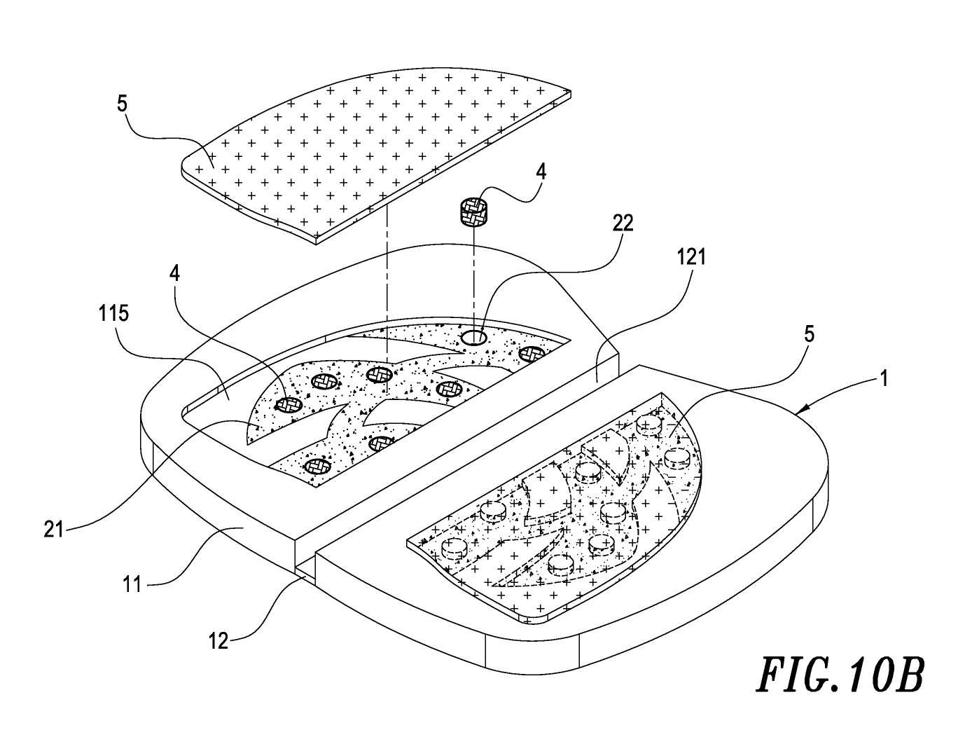

With references to FIG. 10A and FIG. 10B, which illustrate two schematic combination views of a fifth preferred embodiment of the improved cushion structure of the present invention. The differences among FIG. 10A, FIG. 10B, FIG. 1, and FIG. 3 are that a ladder-type upper indentation 115 and a plurality of lower indentations 116 are disposed on the buffering materials 11, the amount of the lower indentation 116 can be one or more, a channel 117 is between every two adjacent lower indentations 116, the surface of the lower indentation 116 has a plurality of positioning holes 118 for fixing wooden stakes (not shown in figure), the flexible melting absorbing material 2 is poured into the lower indentation 116 firstly and flows into the other lower indentations 116 via the channel 117, the flexible layer 21 is formed on the buffering materials 11 after the flexible melting absorbing material 2 is cured, a plurality of connection holes 22 for accommodating a plurality of buffering columns 4 are formed on the flexible layer 21 while the wooden stakes are out of the flexible layer 21. Due to that of the air cells of the buffering column 4, the density of the buffering column 4 is lower than the density of the flexible layer 21, so that the flexible layer 21 can be trembledin all directions for increasing the effect of pressure absorption. Further, the upper indentation 115 of the buffering materials 11 is connected with a buffering piece 5 in order to cover the flexible layer 21 so as to achieve the effects of buffering and pleasing to the eyes.

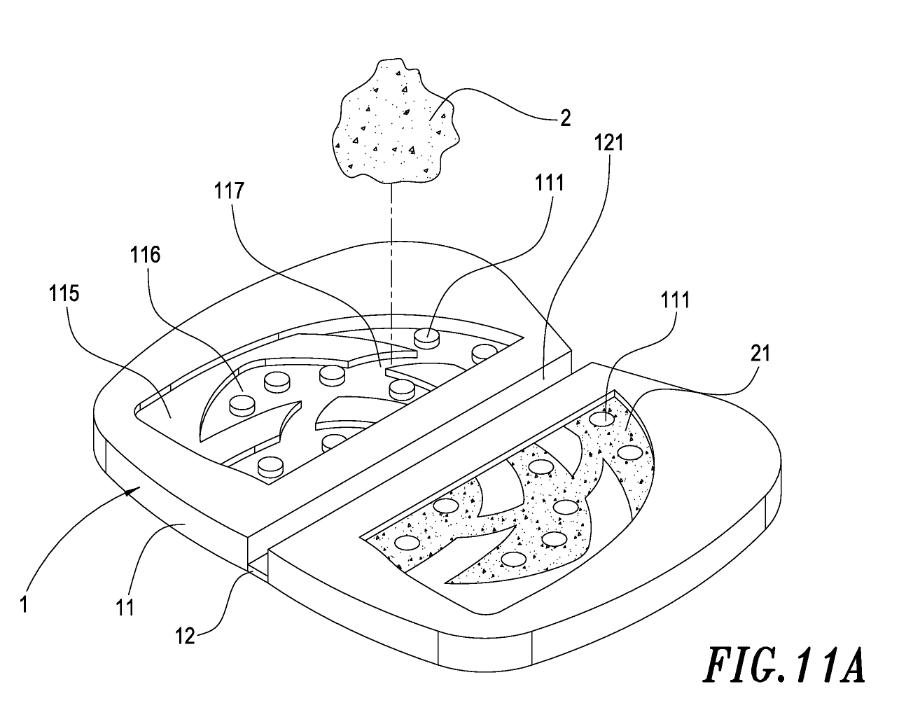

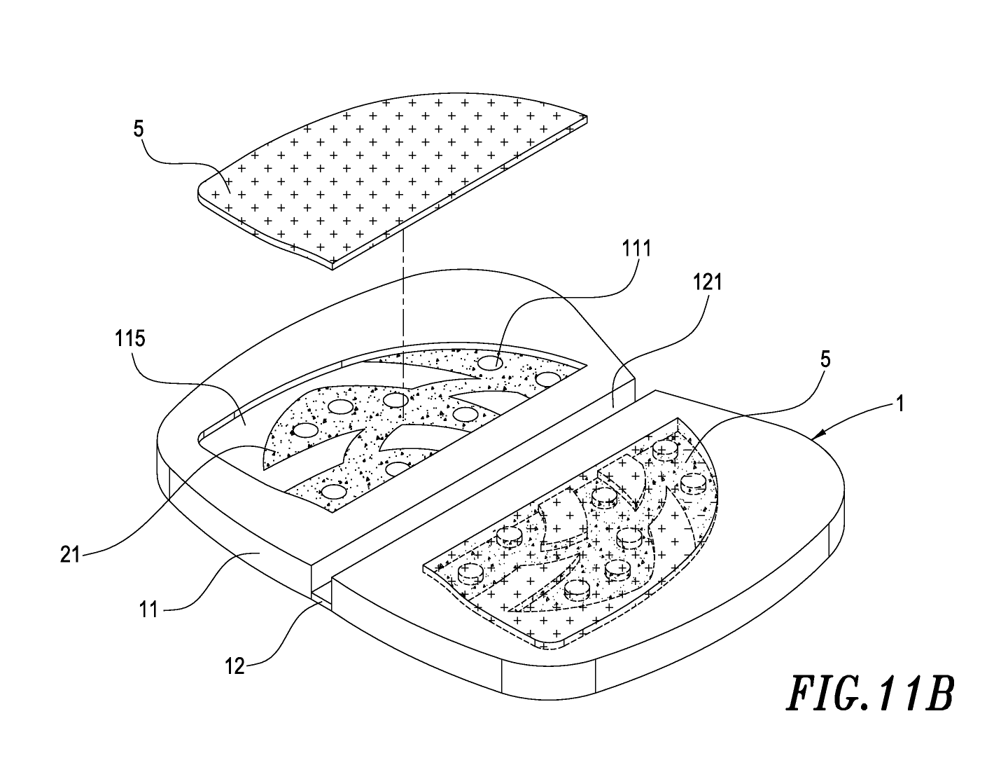

With references to FIG. 11A and FIG. 11B, which illustrate two schematic combination views of a sixth preferred embodiment of the improved cushion structure of the present invention. The differences among FIG. 11A, FIG. 11B, FIG. 10A, and FIG. 10B are that a plurality of buffering columns 111 are integrally extended from the surfaces of the lower indentations 116, the buffering column 111 has air cells so as to have air therein, the top surfaces of the buffering columns 111 and the top surfaces of the lower indentations 116 are the same height or the top surfaces of the buffering columns 111 are lower than the top surfaces of the lower indentations 116. The flexible melting pressure absorbing material 2 is poured into the lower indentation 116 in order to wrapped around the buffering columns 111, the flexible layers 21 are then formed on the buffering materials 11. Due to that of air in the buffering columns 111, the flexible layers 21 can be trembled in all directions for increasing the effect of pressure absorption. Others are the same as FIG. 10A and FIG. 10B and may not be described any further hereinafter.

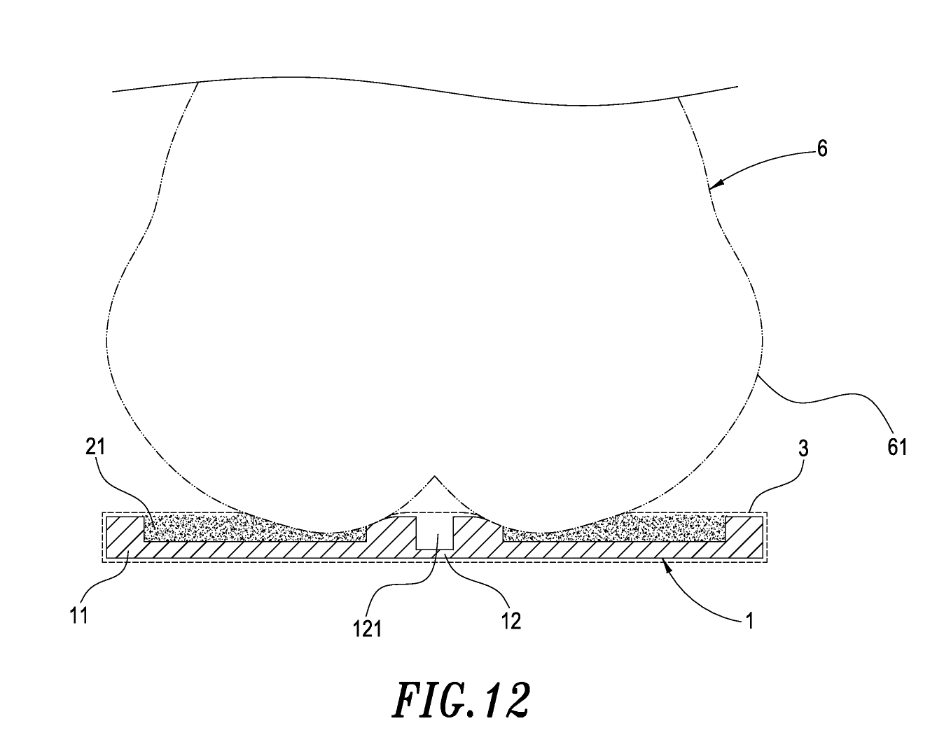

With reference to FIG. 12, which illustrates a schematic application view of the improved cushion structure of the present invention. While a user 6 sits on the pad 1, the flexible layers 21 and the buffering materials 11 absorb the pressure from the user 6, and further that, the sunken channel 121 is able to ventilate the air and heat in the pad 1 in order to avoid miliaria or eczema for a long sitting.

In addition to that the technical characteristics of the present invention can be made as the cushion structure, they are able to be applied to the fields of exercise pad, footrest mat and other related applications as well.

With the comparisons to prior arts, the improved cushion structure of the present invention has the following advantages:
1. The flexible melting pressure absorbing material is poured into the indentations of the buffering materials, the adhesive characteristic of the flexible melting pressure absorbing material is used to let the flexible melting pressure absorbing material adhere to the buffering materials, flexible layers are thus formed on the buffering materials after the flexible melting pressure absorbing material is cured, so that cost-saving, time-saving for manufacturing and environmental protection are achieved.
2. In addition to absorbing the pressure of the user sitting on the pad by means of the buffering materials, the present invention provides a completely comfortable usage for supporting user
3. The connecting portion is a foldable structure, so that the present invention is easily stored and carried out.
4. The sunken channel is among the buffering materials and the connecting portion is able to avoid that hips accumulate too much heat to cause miliaria or eczema while sitting for a long time.
5. The present invention is able to be applied to the cushion products of motorcycle, airplane, automobile, sofa, etc.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. An improved cushion structure comprising:
a pad, being disposed a plurality of buffering materials therein, at least one indentation being disposed at the buffering materials, a connecting portion being between the buffering materials, the height of the connecting portion being lower than the height of the buffering materials so as to have a height difference between the buffering materials and the connecting portion, a sunken channel being existed between the buffering materials correspondingly; and
a flexible melting pressure absorbing material, being filled into the indentations of the buffering materials, a flexible layer being then formed on the buffering materials while the flexible melting pressure absorbing material is cured.

2. The improved cushion structure according to claim 1, further comprising a covering member, which covers around the pad with the flexible layer.

3. The improved cushion structure according to claim 1, wherein the flexible melting pressure absorbing material is selected from the group consisting of: polymer gel, silica gel, compound rubber, and poly urethane.

4. The improved cushion structure according to claim 1, wherein the buffering materials and the connecting portion of the pad are made integrally in one member.

5. The improved cushion structure according to claim 1, wherein the top surfaces of the buffering materials and the connecting portion of the pad have a plurality of through holes in order to increase air-permeability, heat-dissipation and absorption.

6. The improved cushion structure according to claim 1, wherein the buffering material is disposed a plurality of indentations.

7. The improved cushion structure according to claim 1, wherein the buffering materials have a ladder-type upper indentation and a plurality of lower indentations, a channel being between every two adjacent lower indentations, the surface of the lower indentation having a plurality of positioning holes for fixing woodenstakes, the flexible melting pressure absorbing material being poured into the lower indentation firstly and flowing into the other lower indentations via the channel, the flexible layer being formed on the buffering materials after the pressure melting absorbing material is cured, a plurality of connection holes for accommodating a plurality of buffering columns being formed on the flexible layer while the wooden stakes are out of the flexible layer.

8. The improved cushion structure according to claim 7, wherein the upper indentation of the buffering materials is connected with a buffering piece in order to cover the flexible layer.

9. The improved cushion structure according to claim 1, wherein the buffering materials have a ladder-type upper indentation and a plurality of lower indentations, a channel being between every two adjacent lower indentations, the surface of the lower indentation having a buffering columns extended thereon, the lower indentation and the buffering columns being integrally made, the flexible melting pressure absorbing material being poured into the lower indentation firstly and flowing into the other lower indentations via the channel so as to wrapped around the buffering columns, the flexible layer being formed on the buffering materials after the flexible melting pressure absorbing material is cured.

10. The improved cushion structure according to claim 9, wherein the upper indentation of the buffering materials is connected with a buffering piece in order to cover the flexible layer.
